(19) United States
(12) Patent Application Publication
(10) Pub. No.: US 2008/0088073 A1
(43) Pub. Date: Apr. 17, 2008

(54) Hydromechanical Clamping Device With Hydraulically Operated Expanding Means

(76) Inventor: Niclas Rosberg, Norrkoping (SE)

Correspondence Address: STITES & HARBISON PLLC, 1199 NORTH FAIRFAX STREET, SUITE 900, ALEXANDRIA, VA, 22314, US

(21) Appl. No.: 10/567,161

(22) PCT Filed: Sep. 10, 2004
(86) PCT No.: PCT/SE04/01303

§ 371 Date: Feb. 3, 2006

(30) Foreign Application Priority Data
Sep. 12, 2003 (SE) 0302438-7

(51) Int. Cl. B23B 31/40

(52) U.S. Cl. 269/48.1

(57) ABSTRACT

Hydromechanical clamping device which in one end thereof is designed as a mandrel pin with an outer envelope surface onto which one or more tools may be mounted. The mandrel pin 5 comprises outer expanding means (6), the outer surface of which consisting of said envelope surface, with a relatively thin, radially expandable wall and a conical inner surface in the axial direction, the mandrel pin further comprising a centre pin (8), the outer diameter of which being smaller than 10 the diameter of the inner surface of said means, wherein in the space between the centre pin (8) and the expanding means there are arranged intermediate means (7) connected to a piston (9). The intermediate means (7) are displaceable in the axial direction by means of hydraulically operating means, 15 wherein the intermediate means (7) and the outer expanding means (6) have interacting conical surfaces which at axial displacement of the intermediate means in one direction cause radial expansion of the outer expanding means (6), wherein axial displacement of the intermediate means in the other 20 direction causes relief with radial contraction of the outer expanding means (6).

### TECHNICAL FIELD

The present invention relates to a hydro mechanical clamping device according to the preamble of claim 1.

### BACKGROUND OF THE INVENTION

Clamping devices, which with one end thereof are intended to be mounted in a rotary or possibly a non-rotary machining device, such as a drilling machine, a milling machine, a lathe machine etc., and with the other end are intended to releasably hold a bore tool, a work piece, a transition element, a hub or a similar object, such as a drill, a milling tool, a rotary saw blade, a grinding wheel etc, are known in various embodiments.

Such clamping devices may be comprised of mandrels. Such known mandrels are generally formed so that exchangeable tools are secured in the direction of rotation of the mandrel by means of mechanical means such as keys, splines or similar means, or by a heat press joint, and, against axial displacement, by means of nuts or screws. Such mechanical locking means do not provide a perfect precision and circular path of the tool, and it may often be difficult to provide a perfect centring, which in turn may give rise to unbalance and vibrations in the working tool and the machining device due to the unbalance. It may also often be a difficult and time-consuming operation to release the joint between the mandrel and the tools, especially in the case where the tools are mounted by heat press joints.

WO98/32562 A1 discloses a mandrel embodied as a hydraulic clamp bushing with a relatively thin outer wall and radially, inside said outer wall an all around extending pressure medium gap, filled with a hydraulic pressure medium which, when being pressurised, causes said outer wall to expand radially outwards and thereby centre and clamp tools on the clamp body.

WO98/32560 A1 discloses a mandrel which is formed as a hydromechanical clamp bushing comprising a sleeve which is formed integral with the mandrel, said sleeve having a relatively thin wall and an inner surface which is slightly conical towards the free end of the sleeve, the clamp bushing further comprising a piston which is axially displaceable inside the inner of the sleeve, and which has the same conical shape as the inner surface of the sleeve. In order to achieve a displacement of the piston in the sleeve, said sleeve is closed at the outer end by means of a nipple, which makes it possible to introduce a hydraulic pressure medium for forcing the piston in the sleeve, thereby providing a radial expansion of the sleeve and a locking of e.g. a tool.

WO97/13604 A1 discloses a mandrel formed with an outer sleeve having a relatively thin expandable wall and having a conical inner surface in the axial direction, and an inner sleeve connected to a piston. The inner sleeve and the outer sleeve have interacting conical surfaces, and radial expansion of the outer sleeve is achieved by way of axial displacement of the inner sleeve by means of the piston in one direction, and axial displacement of the inner sleeve in the other direction causes a relief with a radial contraction of the outer sleeve.

Apart from the above mentioned problems/disadvantages with existing mandrels, the rigidity against flexing is a common problem for mandrels according to the prior art. That is, when using powerful tools, vibrations might arise due to too low rigidity against flexing in the tool mount of the machine. The vibrations might give rise to a rough machined surface.

There is thus a need for mandrels that are both cheap and of a simple construction and that at the same time have a high rigidity against flexing for making precision machining with powerful tools possible.

### Aim and Most Important Features of the Invention

The object of the present invention is to provide a hydromechanical clamping device that solves the above problems.

This object is achieved by a hydromechanical clamping device as set forth in claim 1.

The present invention provides a hydromechanical clamping device which in one end thereof is designed as a mandrel pin with an outer envelope surface onto which one or more tools may be applied. The mandrel pin comprises outer expanding means, the outer surface of which consisting of said envelope surface and having a relatively thin, radially expandable wall and a conical inner surface in the axial direction, the mandrel pin further comprising a centre pin, the outer diameter of which being smaller than the diameter of the inner surface of said means, wherein in the space between the centre pin and the expanding means there are arranged intermediate means connected to a piston. The intermediate means are displaceable in the axial direction by way of hydraulically operating means, wherein the intermediate means and the outer expanding means have interacting conical surfaces which at axial displacement of the intermediate means in one direction cause radial expansion of the outer expanding means, wherein axial displacement of the intermediate means in the other direction causes relief with radial contraction of the outer expanding means.

This has the advantage that a strong tool mount with very good centring and balancing of the tool is obtained, and at the same time the arrangement provides a strongly clamped tool. This further has the advantage that force reception over the centre pin is obtained, the solid construction of the centre pin allowing a good torque reception and thereby a high rigidity against flexing.

The outer expanding means and/or the intermediate means may consist of an outer sleeve and/or an intermediate sleeve. This has the advantage that the outer expanding means and/or the intermediate means may have a uniform envelope surface.

The hydraulic means may include a pressurisation chamber arranged at one end of the piston, and a pressure relief chamber at the other end of the piston. The chambers are capable of being filled and pressurised by a hydraulic pressure medium. This has the advantage that a simple mounting and dismantling process is obtained.

The interacting conical surfaces may have a conicity that is self locking. This has the advantage that the pressure chambers may be relieved in operation.

A sealing means, for example in the shape of a sealing ring may be arranged between the piston and a cylindrical wall of a chamber enclosing the piston. This has the advantage that shunting of hydraulic fluid between the ends of the piston may be avoided.

A sealing means may also be arranged between the centre pin and the intermediate sleeve. This has the advantage that a dismantling pressure that is lower than the mounting pressure may be used.

The clamping device may to a large extent be integrated in the part intended for mounting in a machining device. This has the advantage that an even higher rigidity against flexing may be achieved. This further has the advantage that a compact and handy mandrel is obtained.

The clamping device may have follower bores and/or follower pins for the connection to corresponding follower pins and/or follower bores of the tool. This has the advantage that an even safer tool mount is obtained.

### BRIEF DESCRIPTION OF THE DRAWINGS

The invention will now be described more in detail by means of exemplary embodiments and with reference to the accompanying drawings, in which:

FIG. 1 shows an embodiment of a mandrel according to the present invention.

FIG. 2 shows the force flow in an embodiment of the present invention.

FIG. 3 shows an alternative embodiment of a mandrel according to the present invention.

FIG. 4 shows a spindle according to the present invention.

### DETAILED DESCRIPTION OF PREFERRED EMBODIMENTS OF THE INVENTION

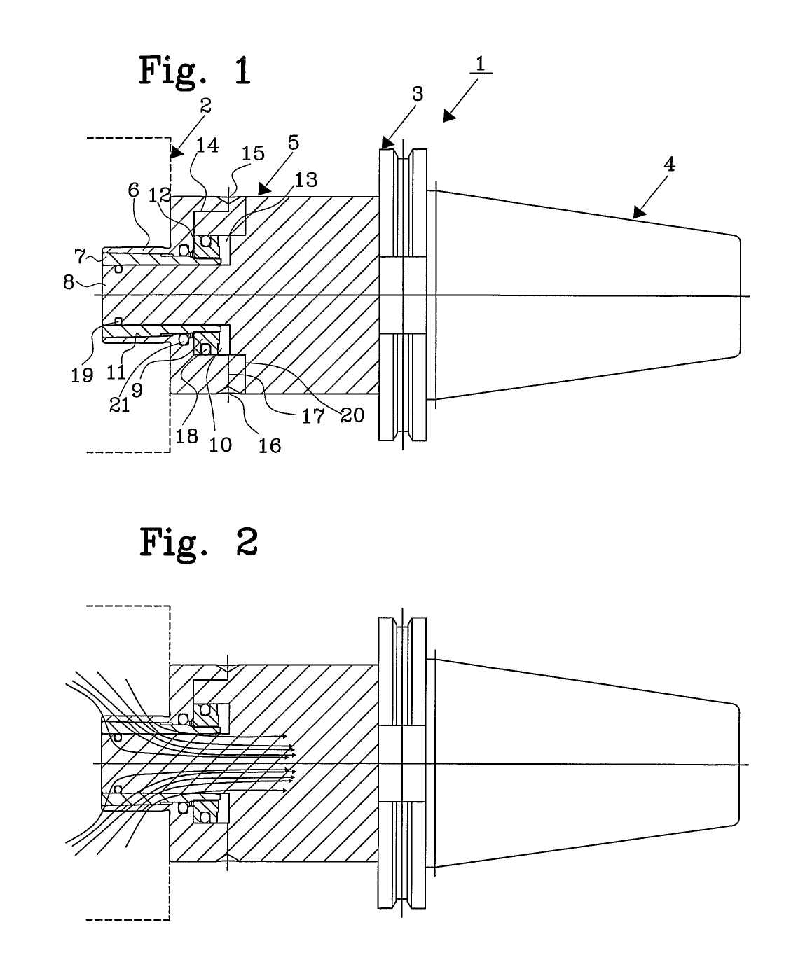

FIG. 1 shows a hydromechanical mandrel 1 according to the invention in a partly sectioned open condition.

The mandrel 1 shown in the figure consists of a transition part 3, for instance in the form of a V-shaped flange, a cone 4 for connection in a corresponding conical cavity of a rotary or non-rotary machining device, and a mandrel pin or clamp body 5 for releasable connection of one or more tools 2 and for securing the same on the clamp body 5. The transition part 3, the cone 4 and the clamp body 5 form an integral unit.

The transition part 3 and the cone 4 are of a type known in the art and need not be described in detail. The cone 4 is adapted for being introduced in a corresponding conical cavity of a rotating machining device, such as a drilling machine, a lathe machine, a milling machine or a similar machine. It is of course also possible to form the cone as an integral part of the machining device, whereby only the clamp body constitutes the inventive part of the device. This is illustrated in FIG. 4, which shows a machine spindle 40 with an integrated clamp body 41 according to the present invention. The figure also shows that the spindle 40 is journalled in bearings 42 and 43.

In order to make it possible to connect one or more tools 2 onto the mandrel, the clamp body is formed with outer expanding means in the form of an outer sleeve 6, intermediate means in form of an intermediate sleeve 7 and a centre pin 8.

The clamp body is also constructed so as to comprise a chamber 10 in which a piston 9 is arranged. The piston 9 is rigidly attached to the intermediate sleeve, e.g. by welding, threading, soldering, gluing or with a combination thereof, such as threading and gluing. Alternatively, the piston 9 may constitute an integrated part of the intermediate sleeve 7.

For manufacturing reasons, the clamp body 5 may advantageously be constructed of two parts that are attached to each other, e.g. by welding, threading, soldering, gluing or with a combination thereof. This is indicated by the joint 20 in FIG. 1.

The outer sleeve 6 has relatively thin walls for making a deformation of these walls possible, especially a radial expansion of the walls towards a tool 2 so that the tool is clamped to the mandrel. The intermediate sleeve 7 is not noticeably deformed by clamping a tool to the outer sleeve 6. The outer sleeve 6 and the intermediate sleeve 7 have interacting peripheral conical surfaces 11, the conicity of which being such that the interacting conical surface is self locking, i.e. after pressurisation the surfaces can not slide on each other by themselves because of the radial pressure acting on the conical surfaces.

The chamber 10 is limited by the piston 9 and the intermediate sleeve 7 so as to form two pressure chambers. A first pressure chamber 12 at the outer end of the piston 9 for causing a displacement of the piston 9, and thereby the intermediate sleeve 7, inwards, i.e. in the clamping direction, to thereby cause, via the intermediate sleeve 7, an expansion of the outer sleeve 6 and consequently a clamping of the tool 2. There is a second pressure chamber 13 at the inner end of the piston 9 for causing a displacement of the piston 9, and thereby the intermediate sleeve 7, in an opposite direction and thereby a release of the tool. The pressure chambers 12 and 13 are arranged to be pressurised by any suitable kind of hydraulic pressure medium. The first pressure chamber 12 is reached via a first connection 15 and a channel 14, and the second pressure chamber 13 is reached via a second connection 16 and a channel 17. The connections 15 and 16, respectively, are suitably connected to an external pressurisation pump (not shown).

When a tool 2 is to be mounted, the tool 2 is pushed onto the outer sleeve 6. Thereafter, the chamber 12 is pressurised with hydraulic medium of a certain predetermined pressure from the connection 15 via the pressure channel 14, the pressure in the chamber 12 causing a displacement of the piston 9, and thus the intermediate sleeve as well, in a locking direction, i.e. towards the transition part 3, whereby the walls of the outer sleeve 6 are expanded radially and the tool 2 is centred and clamped to the expanded outer sleeve 6. Since the conical surfaces 11 are self-locking, there is no risk that the clamp joint will become released.

When releasing the tool 2, the pressure chamber 13 is pressurised from the connection 16 via the channel 17, whereby the piston 9 is pressed towards the outer end of the mandrel, whereby the outer sleeve 6 contracts and regains its original shape at the same time as the tool 2 becomes released.

The pressure chambers 12 and 13 are not pressurised during operation, the clamping of the tool is entirely mechanical. The hydraulic pressurisation is only performed during mounting and dismantling of the tool 2.

The mandrel shown in FIG. 1 may further be provided with follower bores (not shown) on the clamp body with which follower pins may engage to provide a rotating following of the tool. Alternatively, the tool may comprise through bores into which tightening screws may be inserted and threaded into the bores of the flange. Alternatively, the clamp body may be provided with follower pins for engagement with corresponding bores of the tool.

The pressure chambers 12 and 13 may be sealed off between each other in order to avoid that shunting of hydraulic fluid from one pressure chamber to the other might occur, which in turn may have as a result that mounting/dismantling can not be carried out. This seal may advantageously consist of a sealing ring 18 that seals between the piston 9 and the cylindrical outer wall of the chamber.

The arrangement may further be provided with another sealing ring 19 for sealing off between the centre pin 8 and the intermediate sleeve 7 to avoid leakage of hydraulic fluid at the contact surface between the intermediate sleeve 7 and the centre pin 8. This sealing ring is, as shown in FIG. 1, preferably mounted in the vicinity of the outer end of the centre pin 8 to allow lubrication of the contact surface between the intermediate sleeve 7 and the mandrel pin 8 with hydraulic fluid during dismantling. This has the effect that the friction between the intermediate sleeve 7 and the centre pin 8 is higher during mounting than during dismantling since the contact surface between the intermediate sleeve 7 and the centre pin 8 can only be lubricated by the hydraulic medium during dismantling, and since the friction of the intermediate pin towards the centre pin is lower during dismantling than during mounting, the pressure needed during dismantling is lower than the corresponding pressure that has been used during mounting. There is thus no risk that the necessary dismantling pressure is higher than an available pressure, which otherwise may be the case when a dismantling pressure equal to or higher than the mounting pressure is required.

The arrangement may also be provided with a sealing ring 21 for sealing off between the outer surface 6 and the intermediate surface 7 to ensure that no undesired hydraulic fluid leakage occurs between the outer surface 6 and the intermediate surface 7. In this case, the sealing ring 21 together with the sealing ring 18 defines the pressurisation side, while the sealing ring 18 together with the sealing ring 19 defines the dismantling side.

In FIG. 1, the outer sleeve 6 and the intermediate sleeve 7 have been shown as uniform sleeves. The outer sleeve 6 and/or the intermediate sleeve 7 may however also consist of slotted sleeves, where the slots consist of axial recesses. When using a slotted sleeve, a lower force is required to achieve radial expansion as compared to the use of a uniform sleeve. The use of a slotted outer sleeve thus has the advantage that a lower mounting pressure may be used.

The outer surface of the outer sleeve need not be cylindrical but can be adapted to the shape of the tool/work piece that is to be clamp connected. Thus, the cross section of the outer surface may be polygonal, square, octagonal etc.

In the previously known devices the transmission of force is received via a thin outer sleeve. During heavy machining this result in too great vibrations, since the constructions are not capable of receiving in particular the moments of flexure that the arrangement is subjected to. The construction of the present invention has as result that the received forces is received mostly through the centre pin instead. This is illustrated with arrows in FIG. 2. Thanks to the solid construction of the centre pin, and that it constitutes an integrated portion of the clamp body, it is capable of receiving considerably greater forces than a thin outer sleeve, which has as result that the tool 2 may work under a very high load without the occurrence of vibrations resulting in grooves in cut surfaces. The present invention thus has the advantage that it constitutes a construction with a very high flexural rigidity.

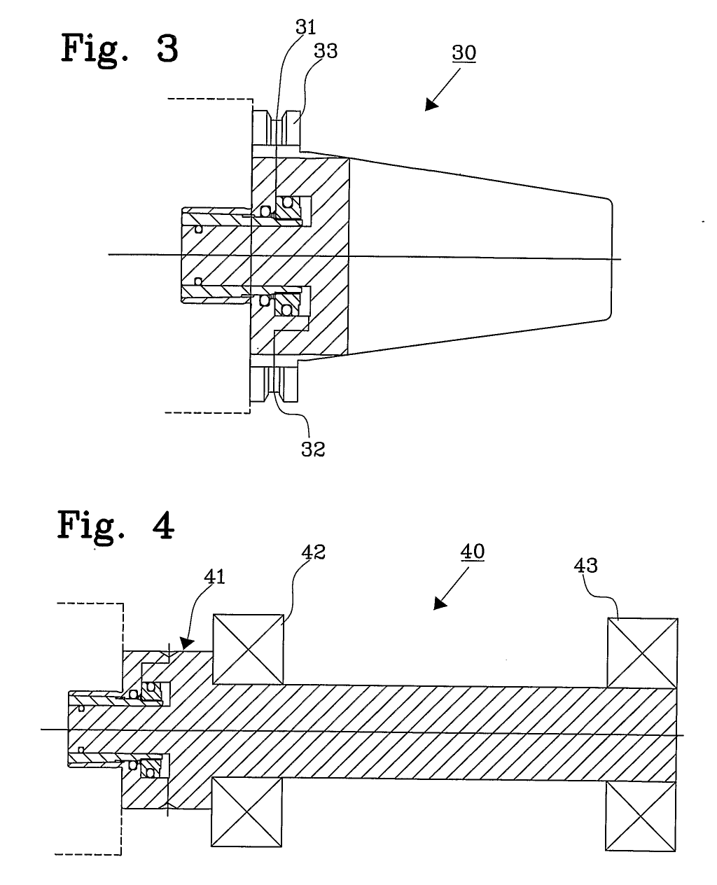

In FIG. 3, an alternative embodiment of the present invention is shown. In the embodiment shown in FIG. 3, the clamp body 5 of FIG. 1 is, apart from the portion which is intended to receive a tool, integrated in the transition part/cone. The pressure chamber connections 31, 32 are in this case situated on the V-shaped transition part 33. The mandrel 30 shown in FIG. 3 makes even higher force reception possible and thereby even better rigidity against flexing for a working tool.

In the above description the conicity of the outer surface of the intermediate sleeve and the inner surface of the outer sleeve have been shown with the diameter increasing towards the outer end of the mandrel. The situation may of course as well be the opposite, i.e. that the diameter decreases towards the outer end of the mandrel.

Further, in the above description the outer expanding means and the intermediate means has been described as an outer sleeve and an intermediate sleeve, respectively. It is to be understood, however, that these means may consist of slotted means or be divided into one or more means that together constitute a whole or parts of a ring or a polygon structure.

The mandrel can be reused several times. It is of course also possible to keep the tool clamped in the mandrel and to remove the entire mandrel from the machining device and to keep the combined unit of mandrel and tool for subsequent working with the same tool.

1. Hydromechanical clamping device which in one end thereof is designed as a mandrel pin with an outer envelope surface onto which one or more tools may be mounted, characterised in that the mandrel pin comprises outer expanding means (6), the outer surface of which consisting of said envelope surface, with a relatively thin, radially expandable wall and a conical inner surface in the axial direction, the mandrel pin further comprising a centre pin (8), the outer diameter of which being smaller than the diameter of the inner surface of said means, wherein in the space between the centre pin (8) and the expanding means there are arranged intermediate means (7) connected to a piston (9), which intermediate means (7) are displaceable in the axial direction by means of hydraulically operating means, wherein the intermediate means (7) and the outer expanding means (6) have interacting conical surfaces which at axial displacement of the intermediate means in one direction cause radial expansion of the outer expanding means (6), wherein axial displacement of the intermediate means in the other direction causes relief with radial contraction of the outer expanding means (6).

2. Clamping device according to claim 1, characterised in that the outer expanding means (6) and/or the intermediate means consists of a sleeve (7).

3. Clamping device according to claim 1, characterised in that the hydraulic means include a pressurisation chamber (12) arranged at one end of the piston (9), and a relief chamber (13) at the other end of the piston (9), which chambers (12, 13) are capable of being filled and pressurised by a hydraulic pressure medium.

4. Clamping device according to claim 1, characterised in that the conicity of the intermediate sleeve (7) is arranged such that the diameter of the intermediate sleeve (7) increases towards its outer end.

5. Clamping device according to claim 1, characterised in that the interacting conical surfaces have a conicity so as to be self-locking.

6. Clamping device according to claim 1, wherein the piston (9) is arranged in a chamber, characterised in that a sealing means, preferably in the shape of a sealing ring (18), is arranged between the piston (9) and a cylindrical outer wall of the chamber.

7. Clamping device according to claim 1, characterised in that a sealing means, preferably in the shape of a sealing ring (19), is arranged between the centre pin (8) and the intermediate sleeve (17).

8. Clamping device according to claim 1, characterised in that a sealing means, preferably in the shape of a sealing ring (21), is arranged between the outer sleeve (6) and the intermediate sleeve (7).

9. Clamping device according to claim 1, characterised in that the device is substantially integrated in the part intended for mounting in a machining device.

10. Clamping device according to claim 1, characterised in that the device consists of an integrated portion of a machine spindle.

11. Clamping device according to claim 1, characterised in that the clamping device have follower bores and/or follower pins for connection to corresponding follower pins and/or follower bores of the tool.
